(19) United States
(12) Patent Application Publication
(10) Pub. No.: US 2025/0211929 A1
(43) Pub. Date: Jun. 26, 2025

(54) CUSTOMIZING OVER-THE-COUNTER HEARING AIDS WITHOUT AUDIOGRAM

(71) Applicant: The Regents of the University of California, Oakland, CA (US)

(72) Inventor: Fan-Gang Zeng, Irvine, CA (US)

(73) Assignee: The Regents of the University of California, Oakland, CA (US)

(21) Appl. No.: 18/989,366

(22) Filed: Dec. 20, 2024

Related U.S. Application Data
(60) Provisional application No. 63/613,367, filed on Dec. 21, 2023.
(60) Provisional application No. 63/560,454, filed on Mar. 1, 2024.

(51) Int. Cl. H04R 25/00

(52) U.S. Cl. CPC H04R 25/70; H04R 25/353; H04R 25/558; H04R 2225/61; H04R 2430/01

(57) ABSTRACT

An over-the-counter (OTC) hearing aid includes a microphone for receiving input audio signals. a processing system that recieves and processes the input audio signal, and an output speaker configured to output the processed audio signal to a subject's ear canal. The processing system is configued to apply gains to the input audio signals to form a processed audio signal. Advantageously, the gains are determined from an input-output function that includes: (1) an expansion region at low input levels at levels from 0 dB SPL to 30 dB SPL, (2) a compression-amplification region at low-to-moderate levels at levels between 30 dB SPL and 70 dB SPL, (3) a no-amplification region at high levels between 70 dB SPL and 117 dB SPL, and (4) a hard limit at 117 dB SPL output or above.

### CROSS-REFERENCE TO RELATED APPLICATIONS

This application claims the benefit of U.S. provisional application Ser. No. 63/613,367 filed Dec. 21, 2023, and U.S. provisional application Ser. No. 63/560,454 filed Mar. 1, 2024, the disclosures of which are hereby incorporated in their entirety by reference herein.

### TECHNICAL FIELD

In at least one aspect, the present invention relates to over-the-counter (OTC) hearing aids.

### BACKGROUND

On Oct. 17, 2022, the U.S. Food and Drug Administration (FDA) introduced a new category of over-the-counter (OTC) hearing aids specifically designed for adults aged 18 or older with perceived mild to moderate hearing loss. This regulatory shift aims to make hearing aids more accessible and affordable, eliminating the need for medical prescriptions or professional fitting. By addressing barriers to entry, the initiative seeks to empower individuals with hearing impairments to independently manage their condition, thereby improving their auditory experience and overall quality of life.

Despite their benefits, a significant challenge remains in customizing OTC hearing aids to individual needs without involving licensed professionals. Current hearing aids typically rely on audiograms, which measure the softest sound a person can hear across various audio frequencies, to tailor their settings. However, obtaining an audiogram requires specialized medical equipment and a visit to a healthcare professional, creating obstacles for those who seek the simplicity and convenience that OTC solutions are intended to provide. These barriers can deter many potential users from accessing effective hearing assistance.

Accordingly, there is a need for innovative methods to configure OTC hearing aids without the necessity of an audiogram. Such solutions would enhance user autonomy and accessibility while maintaining the effectiveness of hearing aids, fulfilling the promise of OTC devices as a viable alternative for individuals with mild to moderate hearing loss.

### SUMMARY

In at least one aspect, the invention customizes the OTC hearing aids based on the maximum output level and two to four possible mild-to-moderate hearing loss profiles without the need to obtain an audiogram.

In another aspect, an over the counter (OTC) hearing aid includes a micorphone for recieving input audio signal, a processing system that recieves and processes the input audio signal, and an output speaker configured to output the processed audio signal to a subject's ear canal. The processing system is configued to apply gains to the input audio signals to form a processed audio signal. Advantageously, the gains are determined from an input-output function that includes: (1) an expansion region at low input levels at levels from 0 dB SPL to 30 dB SPL, (2) a compression-amplification region at low-to-moderate levels at levels between 30 dB SPL and 70 dB SPL, (3) a no-amplification region at high levels between 70 dB SPL and 117 dB SPL, and (4) a hard limit at 117 dB SPL output or above.

In another aspect, an over-the-counter (OTC) hearing can be configured to apply gains at sound frequencies greater than 1500 Hz for mild hearing loss; and/or apply gains at sound frequencies greater than 1500 Hz for moderate hearing loss such that the gains for moderate hearing loss are greater than the gains for mild hearing loss Different gains can be further applied to sound frequencies greater than 1500 Hz, in which the gain can be either mild or moderate for two frequency ranges: (1) 1500 and 4000 Hz, and (2) 4000 and 10,000 Hz. [these frequency values are representative and can be slightly different in actual implementation; please add a sentence to specify this effect] For sloping hearing loss, the gain for the first frequency range is less than that for a second frequency range; for notched hearing loss, the gain for the first frequency range is less than that for the second frequency.

In another aspect, a method for customizing an over-the-counter (OTC) hearing aid without requiring an audiogram is provided. The method includes steps of receiving input audio signals through a microphone and processing the input audio signals using a processing system to apply gains based on an input-output function. Characteristically, the input-output function includes:
a) an expansion region for input levels between 0 dB SPL and 30 dB SPL, wherein minimal or no gain is applied to reduce noise;
b) a compression-amplification region for input levels between 30 dB SPL and 70 dB SPL, wherein gain is applied to amplify soft sounds to a comfortable level;
c) a no-amplification region for input levels between 70 dB SPL and 117 dB SPL, wherein no gain is applied; and
d) a hard limit region for output levels above 117 dB SPL, wherein output is capped to prevent excessive loudness. The method further includes a step of outputting processed audio signals through an output speaker to a user's ear canal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic of an OTC hearing aid.

FIG. 2. Two preset fittings of an OTC hearing aid for a person with mild or moderate hearing loss. The grey dashed diagonal line represents no amplification. The two triangles next to the y-axis represent the hearing threshold of mild and moderate hearing loss, respectively. The arrowed horizontal lines show restored “soft” loudness to an otherwise barely or not audible 30-dB SPL sound in a person with mild or moderate hearing loss.

FIGS. 3A, 3B, 3C, and 3D. One-channel (3A and 3B) or two-channel (3C and 3D), high-frequency amplification for an OTC hearing aid to meet the needs of people with four different mild (black) or moderate (cross hatch) hearing loss profiles. The dashed line represents no amplification.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

Throughout this application, where publications are referenced, the disclosures of these publications in their entireties are hereby incorporated by reference into this application to more fully describe the state of the art to which this invention pertains.

Abbreviations:
“OTC” means over-the-counter.
“SPL” means sound pressure level.

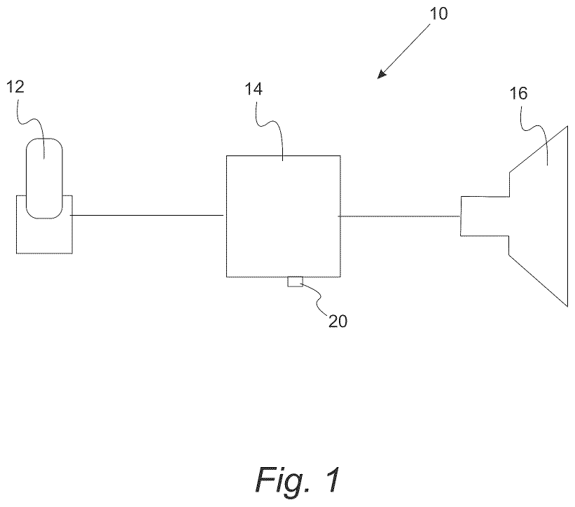

Referring to FIG. 1, an over-the-counter (OTC) hearing aid that can be fitted without an audiogram is provided. OTC 10 includes a microphone 12 configured to receive input audio signals and a processing system 14 that receives and processes the input audio signal. Characteristically, processing system 14 is cconfigured to process the input audio signals and apply gains to form a processed audio signal, Advantageously, the gains are determined from an input-output function that includes: a) an expansion region at input levels between 0 dB SPL and 30 dB SPL, where minimal or no gain is applied to reduce noise; b) a compression-amplification region at input levels between 30 dB SPL and 70 dB SPL, where gain is applied to amplify soft sounds to an audible level; c) a no-amplification region at input levels between 70 dB SPL and 117 dB SPL, where no gain is applied; and d) a hard limit region at output levels above 117 dB SP, where output level is capped to prevent excessive loudness. In a refinement, the gains are associated with a gain profile. OTC 10 also includes an output speaker 16 configured to output the processed audio signal to a subject's ear canal. In a refinement, OTC 10 can include a switch 20 for selecting between a first input-output function for mild hearing loss and a second input-output function for moderate hearing loss.

In this regard, it should be appreciated that an audiogram and an input-output function serve distinct purposes in understanding and managing hearing loss. An audiogram is a diagnostic tool that measures a person's hearing thresholds, or the softest sounds they can hear, at specific frequencies. It plots frequency (Hertz) on the x-axis and hearing level (decibels SPL) on the y-axis, providing a detailed map of the extent and pattern of hearing loss, such as flat, sloping, or notched loss. Audiograms are used for diagnostic purposes and require professional testing in clinical settings. In contrast, an input-output function determines how a hearing aid amplifies sounds based on their input levels. It divides amplification behavior into four regions: an expansion region for reducing noise at very low input levels, a compression-amplification region for boosting soft-to-moderate sounds, a no-amplification region for loud sounds to prevent discomfort, and a hard limit region that caps output to protect against excessively loud sounds. Together, the input-output function ensures appropriate amplification across varying sound intensities, delivering clear and comfortable hearing.

Preset gain profiles, on the other hand, are pre-programmed amplification settings tailored to specific hearing loss patterns, such as mild or moderate loss. These profiles determine the amount of gain applied at different frequencies (e.g., frequencies above 1500 Hz). While the input-output function governs how gains are applied across sound levels, the gain profile focuses on frequency-specific adjustments to compensate for hearing loss. By offering predefined configurations, preset gain profiles simplify customization, eliminating the need for professional calibration or audiograms, and enabling users to select an optimal profile for their hearing needs.

The present OTC hearing aid eliminates the need for audiograms by relying on preset gain profiles to address hearing loss. Audiograms, while effective for diagnostics, require professional clinical testing to measure hearing thresholds across frequencies. In contrast, gain profiles apply tailored amplification settings that compensate for varying types of hearing loss. For example, soft sounds (e.g., 30 dB SPL) may be amplified significantly, while loud sounds (e.g., 90 dB SPL) receive little to no gain. Gain profiles can be pre-programmed for common hearing loss patterns, such as mild or moderate loss, or customized by users through physical controls or a smartphone app. This approach simplifies hearing aid setup, improves accessibility, and allows users to achieve effective hearing assistance without professional involvement.

Preset gain profiles are designed to improve speech intelligibility and sound quality by applying frequency-specific amplification, such as gains for frequencies above 1500 Hz. Additional channels can address more complex hearing loss patterns, such as sloping or notched loss. These profiles are preloaded into the hearing aid during manufacturing and can be accessed via physical controls (e.g., switches or dials) or a companion smartphone app. Users can toggle between profiles to find the most suitable setting, with app-based guidance or auditory prompts assisting in the process. Manufacturers can also update gain profiles through software patches, ensuring continued compatibility with evolving standards and user needs.

In addition to preloaded profiles, users can customize gain profiles to suit their specific hearing needs. A companion smartphone app can guide users through a simple hearing test, playing tones or speech at various frequencies and allowing users to adjust gain levels until the sound is clear and comfortable. The customized settings can then be wirelessly uploaded to the hearing aid, such as via Bluetooth. Alternatively, manual controls on the hearing aid, like sliders or buttons, allow users to fine-tune gain levels across frequency bands directly.

Advanced features, such as cloud-based systems or AI-driven customization, can further enhance user experience by analyzing real-world usage data to recommend or refine gain profiles over time. These systems ensure compliance with regulatory requirements, including maximum output limits, by incorporating safeguards to prevent excessive amplification or issuing warnings when unsafe thresholds are approached. By combining preloaded profiles, user-defined adjustments, and intelligent enhancements, the OTC hearing aid delivers a highly personalized, safe, and effective auditory experience.

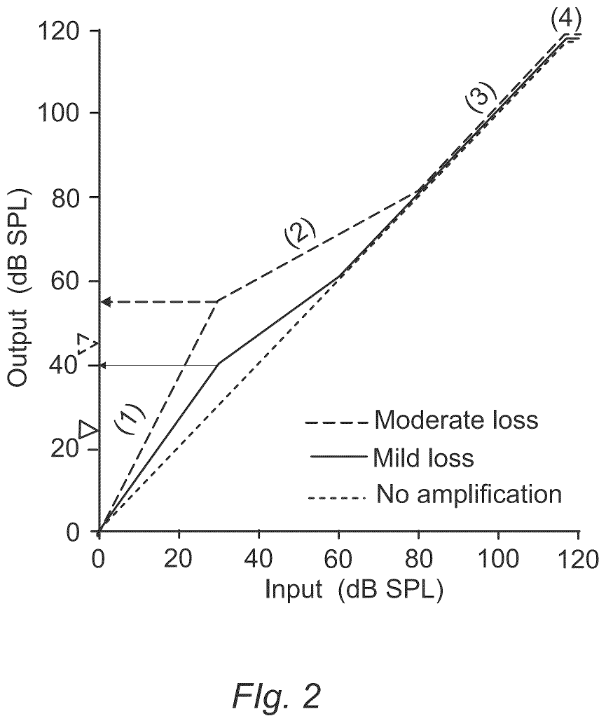

FIG. 2 illustrates how a compression OTC hearing aid can be adapted for its targeted users. According to the FDA, the maximal level is either 111 db SPL for a linear device or 117 dB SPL for a compressive device, which is considered here. The minimal level is either mild or moderate hearing loss (=blue or red triangles on the y-axis, corresponding to ˜25 or 45 dB SPL threshold). The overall input-output function includes four regions set forth above. First, the expansion region minimizes the effects of background noise or pumping sounds associated with amplification. Second, the compression region provides audibility to soft sounds, especially consonants that are critical to speech intelligibility. For example, without amplification, a 30-dB SPL normally soft sound (vertical black line) would be barely or not audible to a person with mild-to-moderate hearing loss. With proper amplification, the 30-dB SPL sound is not only audible but also at approximately “soft” loudness level for a person with mild (arrowed horizontal blue line or 15 dB above the threshold) or moderate hearing loss (arrowed horizontal red line or 10 dB above the threshold). For high-level input sounds, there is no need to provide any, not even linear amplification because of loudness recruitment. Importantly, this no-amplification region will also minimize compression-related distortions that may be audible to a person with mild-to-moderate hearing loss. The final hard limit region not only conforms to the FDA's OTC hearing aid guideline but also helps reduce exposure to loud sounds. We note that this four-stage fitting is similar to an early amplification scheme (Killion, 1993), which suggested no amplification for quiet and loud sounds but a moderate gain for soft sounds. Importantly, because the present fitting amplifies only soft sounds while making loud sounds acoustically transparent, it does not need volume control. We consider this acoustically transparent feature critical to user satisfaction and wide adoption of future OTC hearing aids. Of course, if volume control is installed, then the proposed fitting can be used for users with more than mild-to-moderate hearing loss.

It should be appreciated that the plots of FIG. 2 directly relate to the use of gain profiles in over-the-counter (OTC) hearing aids by describing how specific amplification levels are applied across different input sound ranges to address mild-to-moderate hearing loss. A gain profile determines how much amplification (gain) is applied at various sound levels and frequencies to ensure clear and comfortable hearing. In this case, the input-output function described in the paragraph represents a structured gain profile divided into four regions, each tailored to optimize the hearing aid's performance. In the expansion region (0-30 dB SPL), the gain profile applies minimal or no amplification to prevent background noise and artifacts, such as “pumping sounds,” from becoming overly amplified. In the compression region (30-70 dB SPL), the gain profile increases amplification to make soft sounds, like consonants in speech, audible and comfortable. Here, the gain is carefully calibrated based on the degree of hearing loss: for mild hearing loss, the gain raises the sound level approximately 15 dB above the hearing threshold, while for moderate hearing loss, it raises the level by about 10 dB. This highlights how the gain profile adjusts amplification levels based on specific hearing needs. The no-amplification region (70-117 dB SPL) represents another part of the gain profile where amplification is intentionally turned off. At these higher input levels, users with hearing loss experience loudness recruitment, meaning loud sounds are already perceived as loud without amplification. By excluding amplification in this range, the gain profile reduces sound distortion and enhances sound quality. Finally, in the hard limit region (above 117 dB SPL), the gain profile caps amplification to comply with FDA safety regulations, ensuring that users are not exposed to dangerously loud sounds. In summary, FIG. 2 illustrates how the hearing aid applies a structured gain profile to different input levels: it boosts soft sounds for audibility, minimizes noise at low levels, avoids amplification at higher levels to prevent discomfort, and imposes a hard limit to ensure safety. This thoughtful application of gain profiles makes it possible to effectively address mild-to-moderate hearing loss without requiring audiograms, simplifying the customization process for OTC hearing aid users.

In another aspect, the input-output function is approximated by a line with a first slope in the expansion region and a second slope in the compression-amplification region wherein the first slope is greater than the second slope. In a refinement, the first slope for moderate hearing loss is greater than the first slope for mild hearing loss.

Referring to FIG. 1, the processing system 14 is further configured to apply gains at sound frequencies greater than 1500 Hz for mild hearing loss. In a refinement, processing system 14 is further configured to apply gains at sound frequencies greater than 1500 Hz for moderate hearing loss such that the gains for moderate hearing loss are greater than the gains for mild hearing loss.

In another aspect, the processing system 14 is further configured to apply gains at sound frequencies greater than 1500 Hz. for sloping hearing loss and wherein an average gain for a first frequency range being is less than an average gain for a second frequency range and wherein sound frequencies in the first frequency range are less than frequencies in the second frequency range.

In another aspect, the processing system 14 is further configured to apply gains at sound frequencies greater than 1500 Hz for sloping hearing loss and wherein an average gain for a first frequency range being is less than an average gain for a second frequency range and wherein sound frequencies in the first frequency range are less than frequencies in the second frequency range.

In another aspect, the processing system 14 the processing system is further configured to apply gains at sound frequencies greater than 1500 Hz for notched hearing loss and wherein an average gain for a first frequency range is greater than an average gain for a second frequency range and wherein sound frequencies in the first frequency range are less than frequencies in the second frequency range.

In another aspect, the processing system 14 the processing system applies different gains across two frequency ranges:
a) a first frequency range of 1500-4000 Hz, and
b) a second frequency range of 4000-10,000 Hz.
   In a refinement, a gain in the second frequency range is greater than a gain in the first frequency range for sloping hearing loss. In a further refinement, for notched hearing loss, the gain in the first frequency range is greater than the gain in the second frequency range.

In another aspect, the gains applied in the compression-amplification region increase sound levels to 12 dB to 17 dB above a hearing threshold for mild hearing loss, and 8 dB to 12 dB above a hearing threshold for moderate hearing loss.

In another aspect, the processing system 14 is configured to allow users to toggle between preset gain profiles for different hearing loss types via physical controls or a companion smartphone application. In a refinement, the companion smartphone application enables users to perform a hearing test and customize gain profiles by adjusting gain levels across frequency bands.

In another aspect, the processing system 14 includes a safeguard to prevent amplification beyond regulatory output limits and to issue warnings when unsafe thresholds are approached. In a refinement, the processing system 14 can apply a feature for automatic updates of gain profiles via software patches to maintain compliance with evolving standards and user requirements.

In another aspect, the processing system 14 applies gains using one-channel or two- channel amplification for addressing: a) flat hearing loss, b) high-frequency hearing loss, c) sloping hearing loss, or d) notched hearing loss.

In another aspect, the processing system is further configured to apply gains at sound frequencies greater than 1500 Hz for notched hearing loss and wherein an average gain for a first frequency range is greater than an average gain for a second frequency range and wherein sound frequencies in the first frequency range are less than frequencies in the second frequency range.

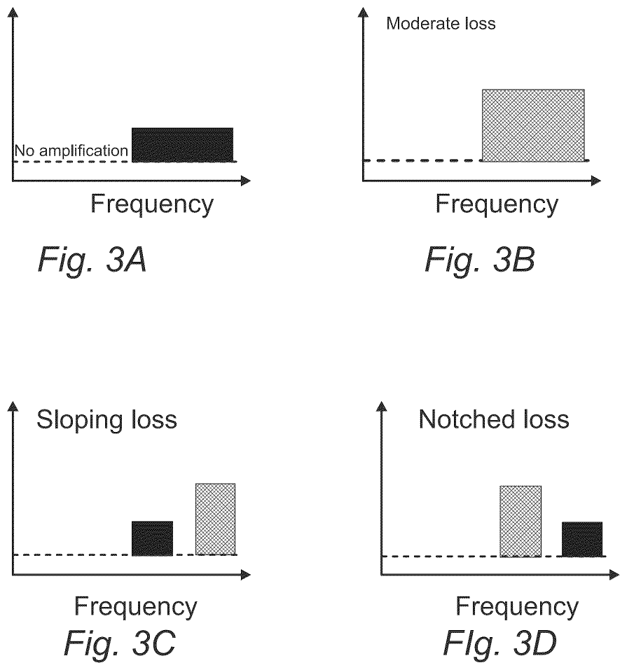

In another embodiment, the processing system can be configured with a limited set of frequency responses without requiring an audiogram. Therefore, a straightforward solution involving high-frequency compression amplification is provided to cater to the needs of most, if not all, OTC hearing aid users. FIG. 3 illustrates two levels of one-channel amplification for sounds above 1500 Hz, providing 20 dB or less amplification for soft sounds in mild loss cases (top panel) and 40 dB or less amplification for soft sounds in moderate loss cases (second panel). This high-frequency amplification is designed to be effective not only for individuals with mild-to-moderate high-frequency loss but also for those with the same degree of flat loss. Previous studies have demonstrated that the frequency response is not a critical parameter as long as speech sounds fall within a listener's dynamic range. (van Buuren et al., 1995). Moreover, low-frequency amplification may sound bloomy and does not provide additional benefits to speech intelligibility (van Buuren et al., 1996).

While most potential OTC hearing aid users have high-frequency or flat hearing loss, some may have relatively steep-sloping or notched hearing loss (Cruickshanks et al., 2020; Parthasarathy et al., 2020; Wang et al., 2021). To further address the need for those with sloping or notched hearing loss, additional two-channel amplification can be provided at high frequencies (bottom two panels in FIG. 3). Together, these four preset amplification profiles can not only satisfy the FDA OTC hearing aid requirements, but more importantly likely meet both speech intelligibility and sound quality needs for people with mild-to-moderate hearing loss. Future investigation is needed to compare performance between hearing aids using these four presets and that fitted with an audiogram in the targeted population.

In another embodiment, a method for customizing an over-the-counter (OTC) hearing aid without requiring an audiogram is provided. The method includes steps of receiving input audio signals through a microphone and processing the input audio signals using a processing system to apply gains based on an input-output function. Characteristically, the input-output function includes:
a) an expansion region for input levels between 0 dB SPL and 30 dB SPL, wherein minimal or no gain is applied to reduce noise;
b) a compression-amplification region for input levels between 30 dB SPL and 70 dB SPL, wherein gain is applied to amplify soft sounds to a comfortable level;
c) a no-amplification region for input levels between 70 dB SPL and 117 dB SPL, wherein no gain is applied; and
d) a hard limit region for output levels above 117 dB SPL, wherein output is capped to prevent excessive loudness. The method further includes a step of outputting processed audio signals through an output speaker to a user's ear canal.

In another aspect, the method icnldues the step of selecting a gain profile corresponding to either mild or moderate hearing loss, wherein the gain profile adjusts amplification levels for sound frequencies greater than 1500 Hz.

In another aspect, the method further includes a step of dividing applied gain at sound frequencies greater than 1500 Hz into two frequency ranges that include a first frequency range between 1500 Hz and 4000 Hz and a second frequency range between 4000 Hz and 10,000 Hz. Characteristically, for sloping hearing loss, the applied gain in the first frequency range is less than the applied gain in the second frequency range. In a variation for notched hearing loss, the applied gain in the first frequency range is greater than the applied gain in the second frequency range.

Additional details are found in Chung King, Zeng Fan-Gang, Over-the-counter hearing aids: implementations and opportunities, Frontiers in Audiology and Otology, Vol. 2, 2024, www.frontiersin.org/journals/audiology-and-otology/articles/10.3389/fauot.2024.1347437, DOI=10.3389/fauot.2024.1347437 ISSN=2813-6055; the entire disclosure of which is hereby incorporated by reference in its entirety.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An over-the-counter (OTC) hearing aid comprising:
a microphone configured to receive input audio signals;
a processing system configured to process the input audio signals and apply gains to form a processed audio signal, wherein the gains are determined based on an input-output function comprising:
a) an expansion region at input levels between 0 dB SPL and 30 dB SPL, where minimal or no gain is applied to reduce noise;
b) a compression-amplification region at input levels between 30 dB SPL and 70 dB SPL, where gain is applied to amplify soft sounds to an audible level;
c) a no-amplification region at input levels between 70 dB SPL and 117 dB SPL, where no gain is applied; and
d) a hard limit region at output levels above 117 dB SP, where output level is capped to prevent excessive loudness; and
an output speaker configured to output the processed audio signal to a subject's ear canal.

2. The OTC hearing aid of claim 1, wherein the input-output function is approximated by a line with a first slope in the expansion region and a second slope in the compression-amplification region wherein the first slope is greater than the second slope.

3. The OTC hearing aid of claim 2, wherein the first slope for moderate hearing loss is greater than the first slope for mild hearing loss.

4. The OTC hearing aid of claim 1, further comprising a switch for selecting between a first input-output function for mild hearing loss and a second input-output function for moderate hearing loss.

5. The OTC hearing aid of claim 1, wherein the processing system is further configured to apply gains at sound frequencies greater than 1500 Hz for mild hearing loss.

6. The OTC hearing aid of claim 5, wherein the processing system is further configured to apply gains at sound frequencies greater than 1500 Hz for moderate hearing loss such that the gains for moderate hearing loss are greater than the gains for mild hearing loss.

7. The OTC hearing aid of claim 1, wherein the processing system is further configured to apply gains at sound frequencies greater than 1500 Hz for sloping hearing loss and wherein an average gain for a first frequency range being is less than an average gain for a second frequency range and wherein sound frequencies in the first frequency range are less than frequencies in the second frequency range.

8. The OTC hearing aid of claim 1, wherein the processing system is further configured to apply gains at sound frequencies greater than 1500 Hz for notched hearing loss and wherein an average gain for a first frequency range is greater than an average gain for a second frequency range and wherein sound frequencies in the first frequency range are less than frequencies in the second frequency range.

9. The OTC hearing aid of claim 1, wherein the processing system applies different gains across two frequency ranges:
a) a first frequency range of 1500-4000 Hz, and
b) a second frequency range of 4000-10,000 Hz,
wherein a gain in the second frequency range is greater than a gain in the first frequency range for sloping hearing loss.

10. The OTC hearing aid of claim 9, wherein for notched hearing loss, the gain in the first frequency range is greater than the gain in the second frequency range.

11. The OTC hearing aid of claim 1, wherein the gains applied in the compression-amplification region increase sound levels to:
a) approximately 15 dB above a hearing threshold for mild hearing loss, and
b) approximately 10 dB above a hearing threshold for moderate hearing loss.

12. The OTC hearing aid of claim 1, wherein the processing system is configured to allow users to toggle between preset gain profiles for different hearing loss types via physical controls or a companion smartphone application.

13. The OTC hearing aid of claim 12, wherein the companion smartphone application enables users to perform a hearing test and customize gain profiles by adjusting gain levels across frequency bands.

14. The OTC hearing aid of claim 1, wherein the processing system includes a safeguard to prevent amplification beyond regulatory output limits and to issue warnings when unsafe thresholds are approached.

15. The OTC hearing aid of claim 1, further comprising a feature for automatic updates of gain profiles via software patches to maintain compliance with evolving standards and user requirements.

16. The OTC hearing aid of claim 1, wherein the processing system applies gains using one-channel or two-channel amplification for addressing:
a) flat hearing loss,
b) high-frequency hearing loss,
c) sloping hearing loss, or
d) notched hearing loss.

17. An over-the-counter (OTC) hearing aid comprising:
a micorphone for recieving input audio signals;
a processing system that recieves and processes the input audio signal, wherein processing system is configured to apply gains to the input audio signals to form a processed audio signal, wherein the processing system is configured to:
apply gains at sound frequencies greater than 1500 Hz for mild hearing loss; and/or
apply gains at sound frequencies greater than 1500 Hz for moderate hearing loss such that the gains for moderate hearing loss are greater than the gains for mild hearing loss; and/or
apply gains at sound frequencies greater than 1500 Hz. for sloping hearing loss and wherein an average gain for a first frequency range being is less than an average gain for a second frequency range and wherein sound frequencies in the first frequency range are less than frequencies in the second frequency range; and/or
apply gains at sound frequencies greater than 1500 Hz for notched hearing loss and wherein an average gain for a first frequency range is greater than an average gain for a second frequency range and wherein sound frequencies in the first frequency range are less than frequencies in the second frequency range.

18. A method for customizing an over-the-counter (OTC) hearing aid without requiring an audiogram, the method comprising:
receiving input audio signals through a microphone;
processing the input audio signals using a processing system to apply gains based on an input-output function, wherein the input-output function comprises:
a) an expansion region for input levels between 0 dB SPL and 30 dB SPL, wherein minimal or no gain is applied to reduce noise;
b) a compression-amplification region for input levels between 30 dB SPL and 70 dB SPL, wherein gain is applied to amplify soft sounds to a comfortable level;
c) a no-amplification region for input levels between 70 dB SPL and 117 dB SPL, wherein no gain is applied; and
d) a hard limit region for output levels above 117 dB SPL, wherein output is capped to prevent excessive loudness; and
outputting processed audio signals through an output speaker to a user's ear canal.

19. The method of claim 18, further comprising the step of selecting a gain profile corresponding to either mild or moderate hearing loss, wherein the gain profile adjusts amplification levels for sound frequencies greater than 1500 Hz.

20. The method of claim 18, further comprising:
dividing applied gain at sound frequencies greater than 1500 Hz into two frequency ranges:
a) a first frequency range between 1500 Hz and 4000 Hz; and
b) a second frequency range between 4000 Hz and 10,000 Hz,
wherein for sloping hearing loss, the applied gain in the first frequency range is less than the applied gain in the second frequency range.

21. The method of claim 20, wherein for notched hearing loss, the applied gain in the first frequency range is greater than the applied gain in the second frequency range.
